(19) United States
(12) Patent Application Publication
(10) Pub. No.: US 2008/0259734 A1
(43) Pub. Date: Oct. 23, 2008

(54) Systems and Methods for Creating Personalized Calendars

(75) Inventor: Mamta Jain, Millbrae, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Fort Collins, CO (US)

(21) Appl. No.: 11/738,044

(22) Filed: Apr. 20, 2007

(51) Int. Cl. G04B 47/00; G06F 17/00; G04C 17/00

(52) U.S. Cl. 368/10; 368/29

(57) ABSTRACT

In one embodiment, a system or system for creating a personalized calendar includes prompting a user to select a date cell of a representation of a calendar to indicate a desire to add user content to that date cell, receiving the date cell selection, prompting the user to select user content for addition to the date cell, receiving the user content selection, and generating a personalized calendar that includes user content in at least one date cell of the calendar.

### BACKGROUND

People often use calendars to track the passage of time as well as to keep track of significant dates. For example, people often use conventional printed calendars that identify the various months of the year on separate pages with each month being divided into separate date cells, one cell being provided for each day of each month. When such a person wishes to keep track of a significant date, it is common to manually mark a date cell with indicia that identifies an event associated with a given date. For example, the person may write in “Moms birthday” in a particular date cell to identify his or her mother's birthday.

Although the above-described practice works adequately well, it would be desirable to be able to produce a personalized calendar that identifies the significant dates with more than handwritten notes. Moreover, it would be desirable to be able to add content to the various date cells beyond a mere textual description of a date's significance.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of a system with which personalized calendars can be created.

FIG. 2 is a block diagram of an embodiment of a client computer shown in FIG. 1.

FIG. 3 is a block diagram of an embodiment of a server computer shown in FIG. 1.

FIG. 4 is a flow diagram that illustrates a first embodiment of a method for creating a personalized calendar.

FIGS. 5A-5C depict a flow diagram that illustrates a second embodiment of a method for creating a personalized calendar.

FIGS. 6A-6I illustrate example web pages of an embodiment of a web site that can be used to create a personalized calendar.

### DETAILED DESCRIPTION

As described above, it would be desirable to be able to produce a personalized calendar that identifies significant dates with more than just handwritten notes. Moreover, it would be desirable to be able to add content to the various date cells beyond a mere textual description of a date's significance. As described in the following, professional-looking, personalized calendars can be created using the disclosed systems and methods. In some embodiments, a personalized calendar can be created that identifies significant dates with one or both of photographic images and computer-generated text. When such images are used, the images can identify the significance of the pertinent date to the user. When text is used, the text can explicitly describe the date's significance.

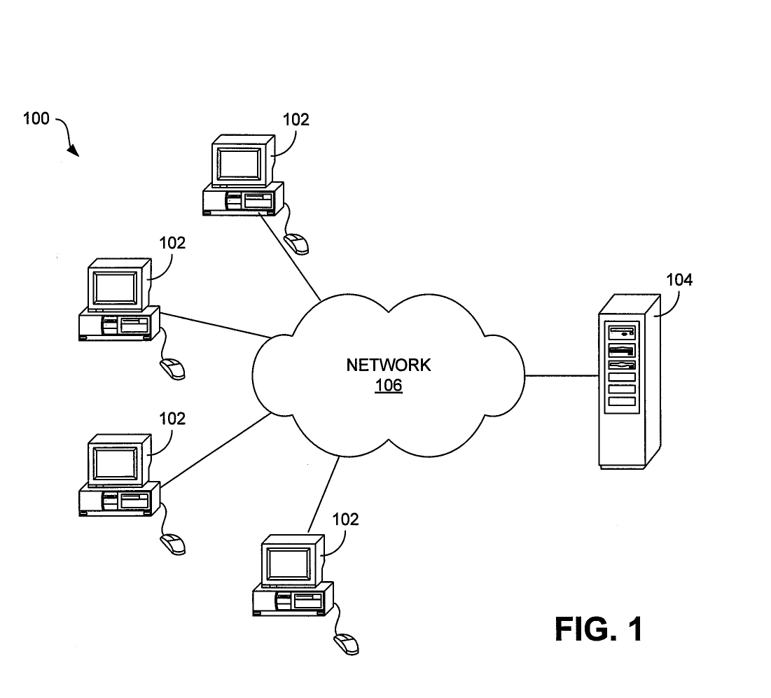

Referring now in more detail to the drawings, in which like numerals indicate corresponding parts throughout the several views, FIG. 1 illustrates an example system 100 that can be used to create personalized calendars. As indicated in that figure, the system 100 generally comprises client computers 102 and a server computer 104. In the embodiment of FIG. 1, the client computers 102 comprise personal computers (PCs) that are configured to communicate with the server computer 104. More particularly, the PCs can be used to access a network service hosted by the server computer 104 and utilize the service to create a personalized calendar. Although PCs are illustrated in FIG. 1 by way of example, it will be appreciated that substantially any computing device capable of accessing and utilizing the network service can be used.

The server computer 104 operates as a host of the network service, e.g., an imaging service, that aids a user in the creation of a personalized calendar. In some embodiments, the imaging service can provide other services to clients, such as photograph and/or video storage, editing, and arrangement.

The network 106 can comprise a single network, such as a local area network (LAN), or a collection of networks (LANs and/or wide area networks (WANs)) that are communicatively coupled to each other. In some embodiments, the network 106 comprises part of the Internet.

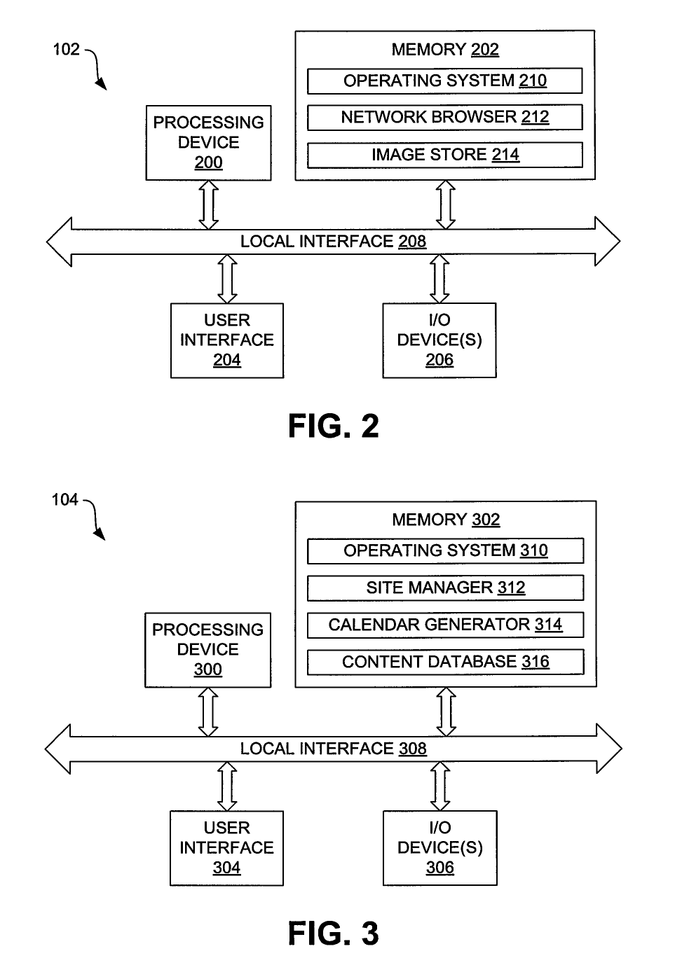

FIG. 2 is a block diagram illustrating an example architecture for one of the client computers 102. The computer 102 of FIG. 2 comprises a processing device 200, memory 202, a user interface 204, and at least one I/O device 206, each of which is connected to a local interface 208.

The processing device 200 can include a central processing unit (CPU) or an auxiliary processor among several processors associated with the computer 102, or a semiconductor based microprocessor (in the form of a microchip). The memory 202 includes any one of or a combination of volatile memory elements (e.g., RAM) and nonvolatile memory elements (e.g., hard disk, ROM, tape, etc.).

The user interface 204 comprises the components with which a user interacts with the computer 102. The user interface 204 may comprise, for example, a keyboard, mouse, and a display, such as a cathode ray tube (CRT) or liquid crystal display (LCD) monitor. The one or more I/O devices 206 are adapted to facilitate communications with other devices and may include one or more communication components such as a modulator/demodulator (e.g., modem), wireless (e.g., radio frequency (RF)) transceiver, network card, etc.

The memory 202 comprises various programs including an operating system 210 and a network browser 212. The operating system 210 controls the execution of other programs and provides scheduling, input-output control, file and data management, memory management, and communication control and related services. The network browser 212 comprises any application that executes on the computer 102 and is capable downloading content, in the form of network sites and pages, for viewing by and interaction of a user. In some embodiments, the network browser comprises an Internet browser, such as Internet Explorer™ or Firefox™. In addition to the programs, the memory 202 can comprise an image store 214 that is used to locally store various photographic images that the user may wish to upload to a network site (e.g., web site) for use in creating a personalized calendar.

FIG. 3 is a block diagram illustrating an example architecture for the server computer 104 (e.g., web server) shown in FIG. 1. As indicated in FIG. 3, the server computer 104 comprises many of the same components as the client computer 102 shown in FIG. 2, including a processing device 300, memory 302, a user interface 304, and at least one I/O device 306, each of which is connected to a local interface 308. In some embodiments, those components have the same or similar construction and/or function of like-named components described above in relation to FIG. 2. Accordingly, a detailed discussion of the components of FIG. 3 is not presented herein.

As indicated in FIG. 3, the memory 302 of the server computer 104 comprises an operating system 310, a network site manager 312, and a calendar generator 314. The operating system 310 controls the execution of other programs and provides scheduling, input-output control, file and data management, memory management, and communication control and related services. In some embodiments, the site manager 312 manages a network site (e.g., web site) of the network service and comprises various network pages (e.g., web pages) that can be presented to requesting client browsers. Selections input with a client browser are received by the server computer 104 and can be acted upon the calendar generator 314 to generate personalized calendars that can, at least in some embodiments, be printed in hard copy form and provided to the clients. In addition, the memory 302 includes a content database 316 that stores various content of the clients, such as uploaded photographic images and input textual descriptions, and associations between the content, the clients, and particular dates of significance for those clients.

Example systems having been described above, operation of the systems will now be discussed. In the discussions that follow, flow diagrams are provided. Process steps or blocks in the flow diagrams may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

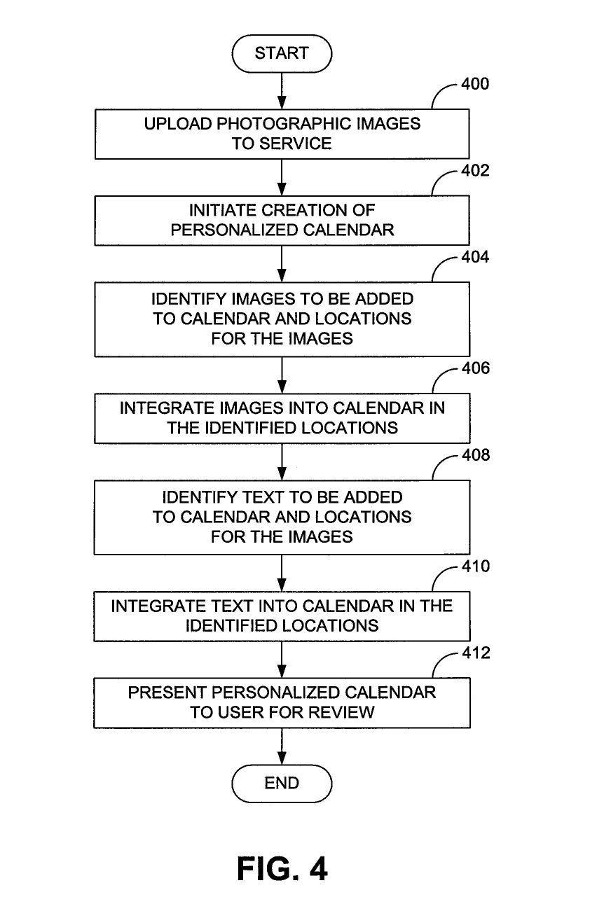

FIG. 4 illustrates an example method for creating a personalized calendar. Beginning with block 400, photographic images that will be used to create the calendar are uploaded to a network service. Next, creation of the calendar is initiated, as indicated in block 402. Once calendar creation has been initiated, images to be added to the calendar and the locations for those images in the calendar are identified, as indicated in block 404. In some cases, the identified images are images that are relevant in some manner to particular dates of the calendar and the identified locations comprise those particular dates. The images can then be integrated into the calendar in the identified locations, as indicated in block 406.

Next, text to be added to the calendar and the locations for that text in the calendar can be identified, as indicated in block 408. In some cases, the identified text is also relevant in some manner to particular dates of the calendar and the identified locations comprise those particular dates. The text can then be integrated into the calendar in the identified locations, as indicated in block 410.

At that point, a personalized calendar has been generated and can be presented to the user for review, as indicated in block 412.

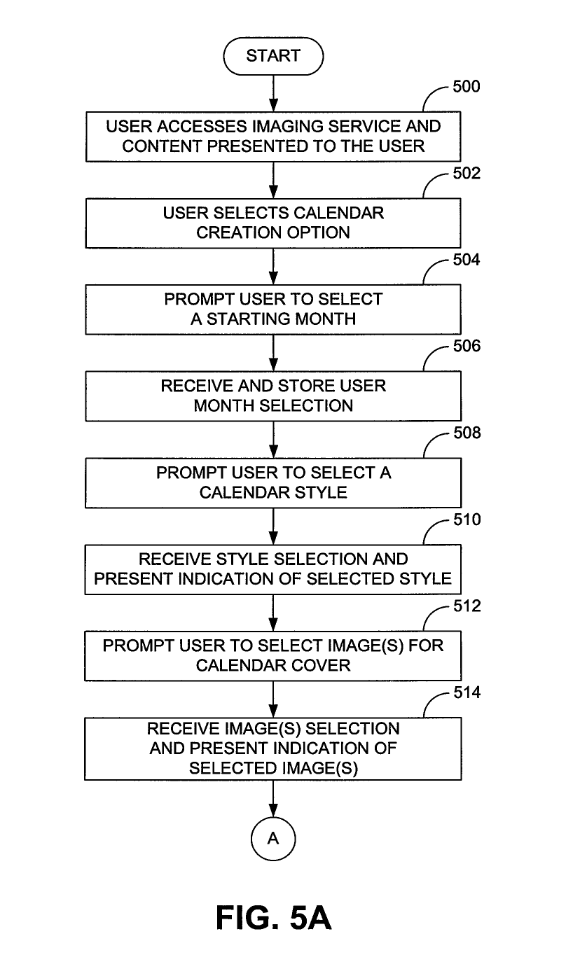

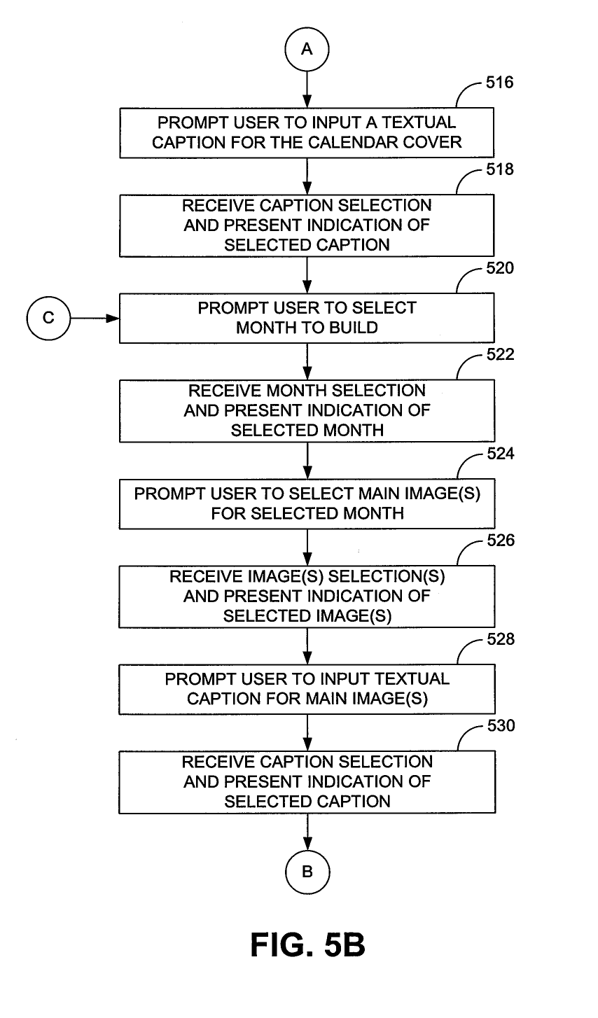

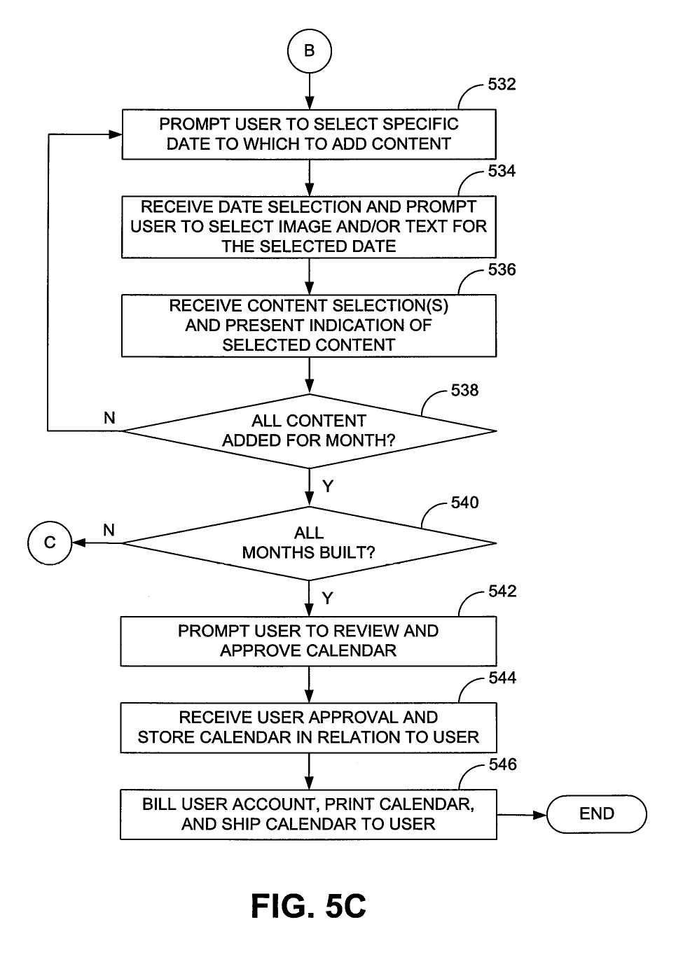

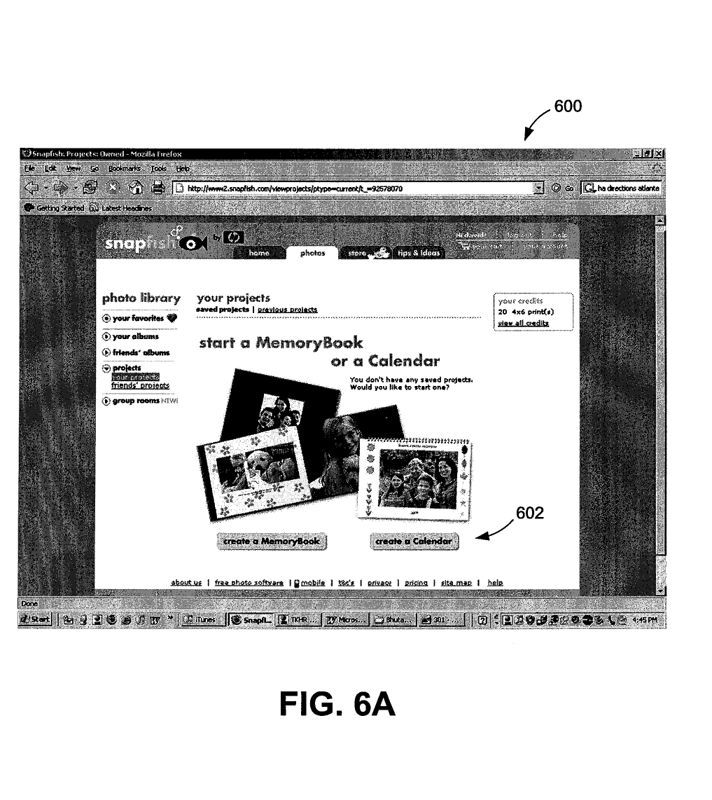

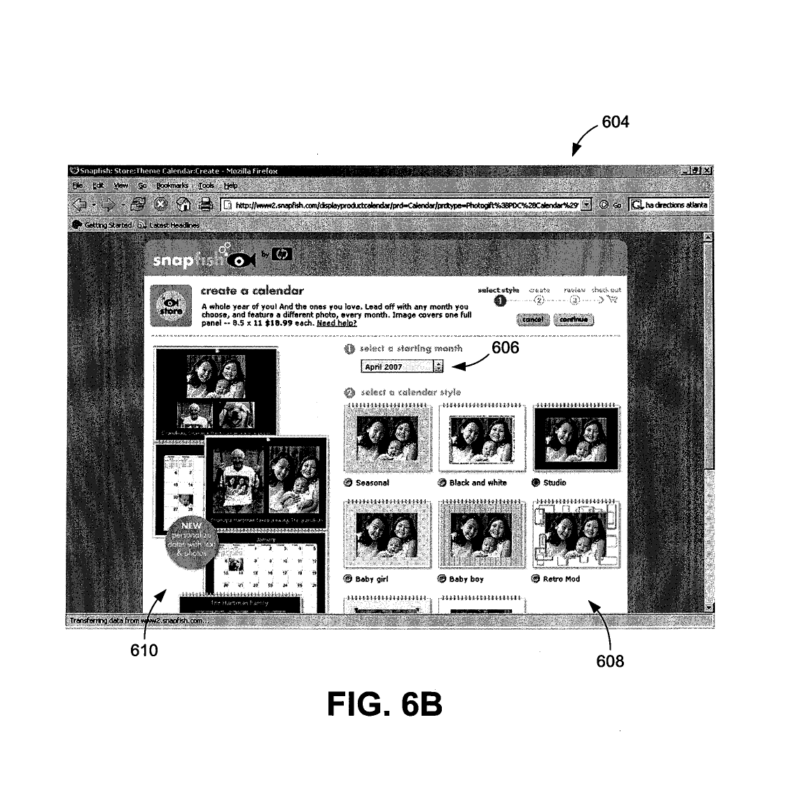

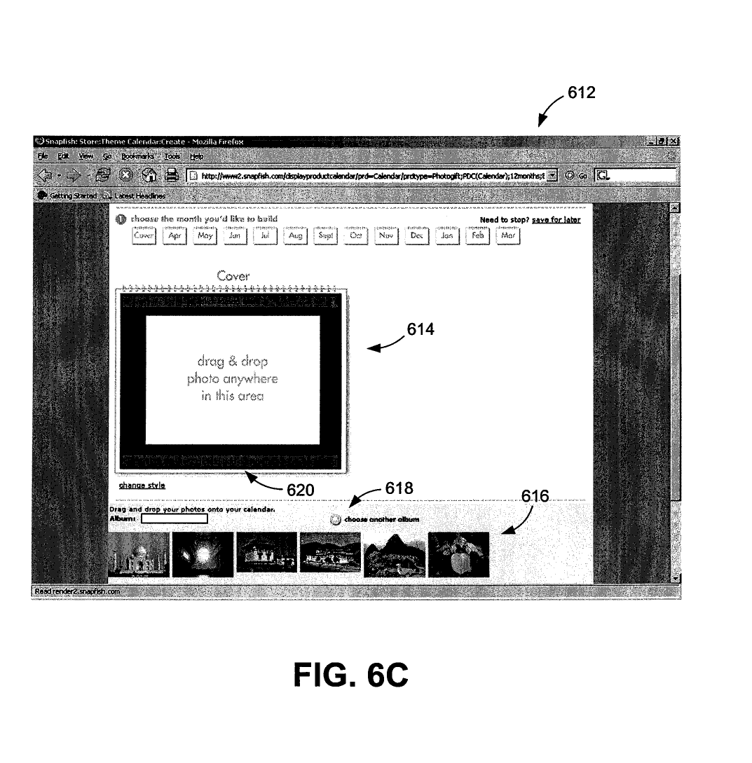

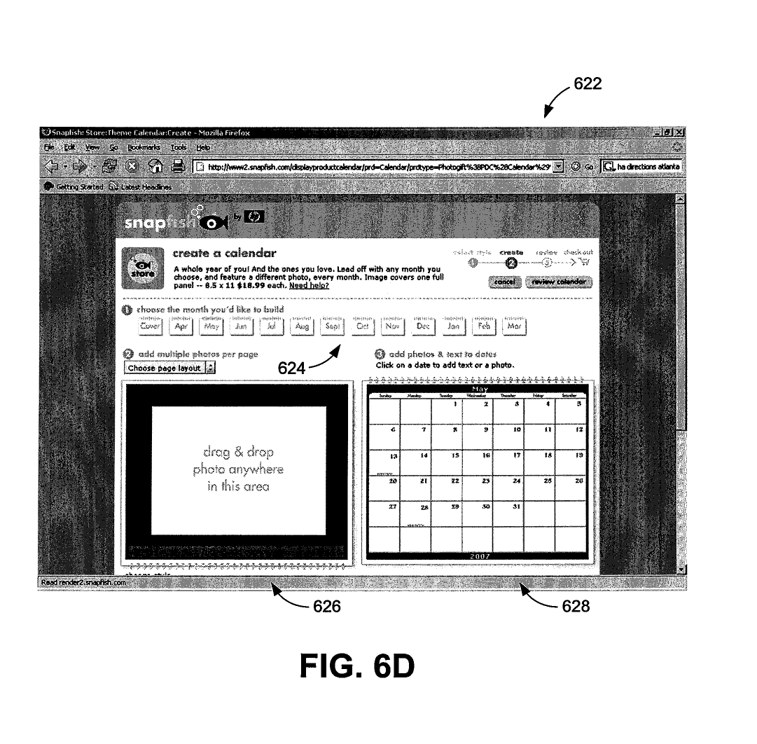

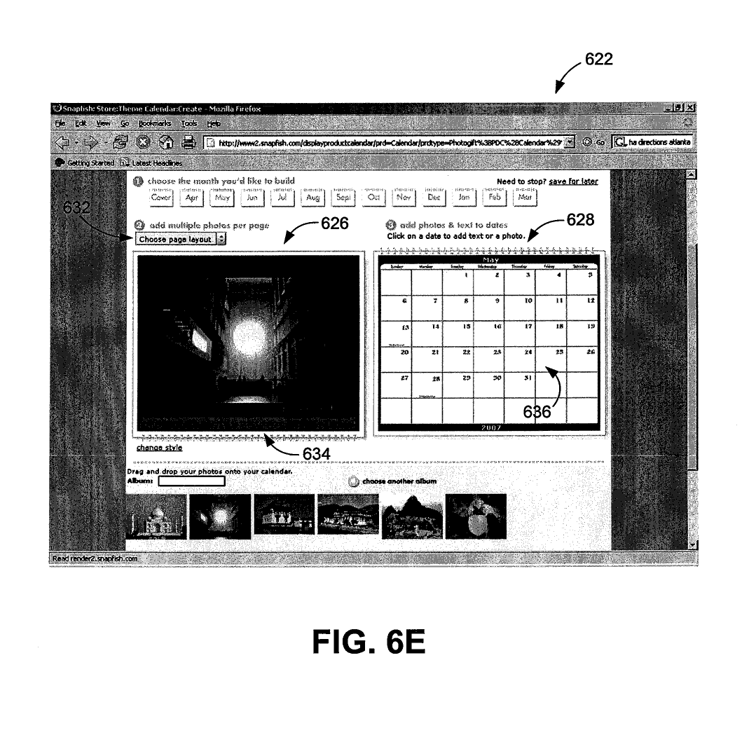

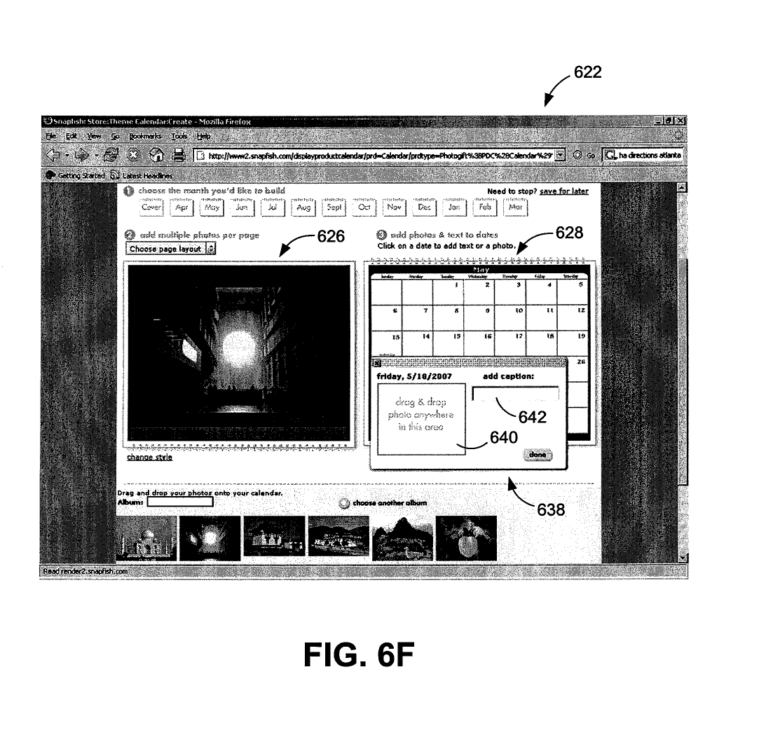

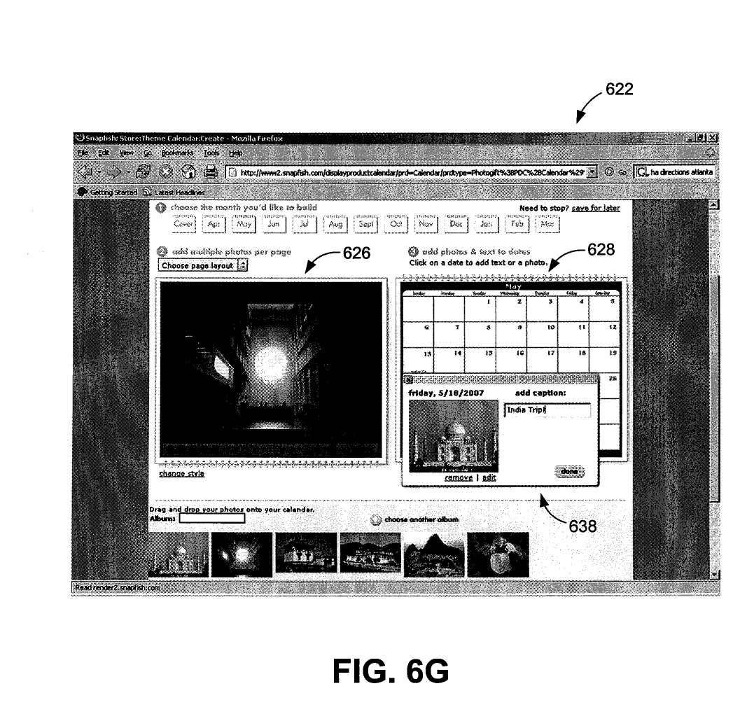

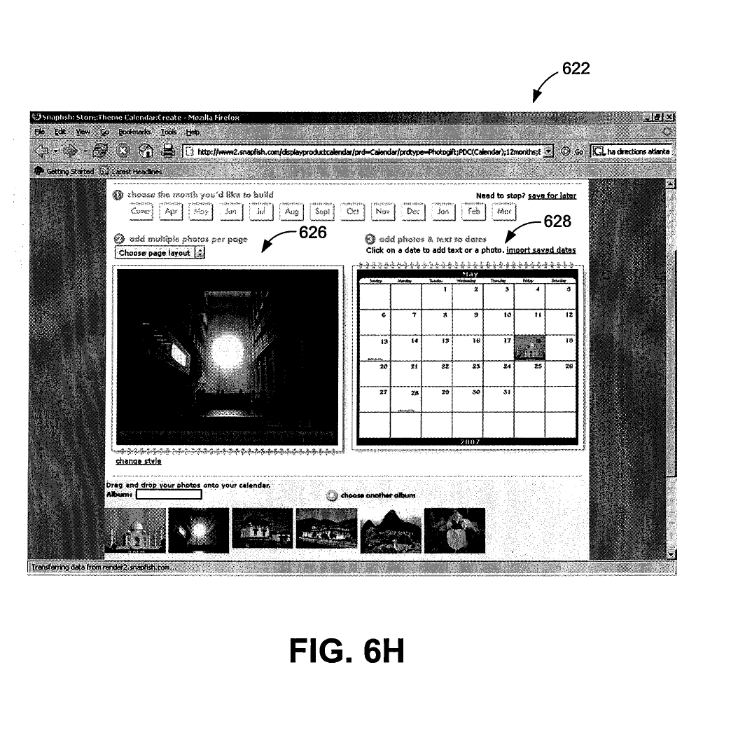

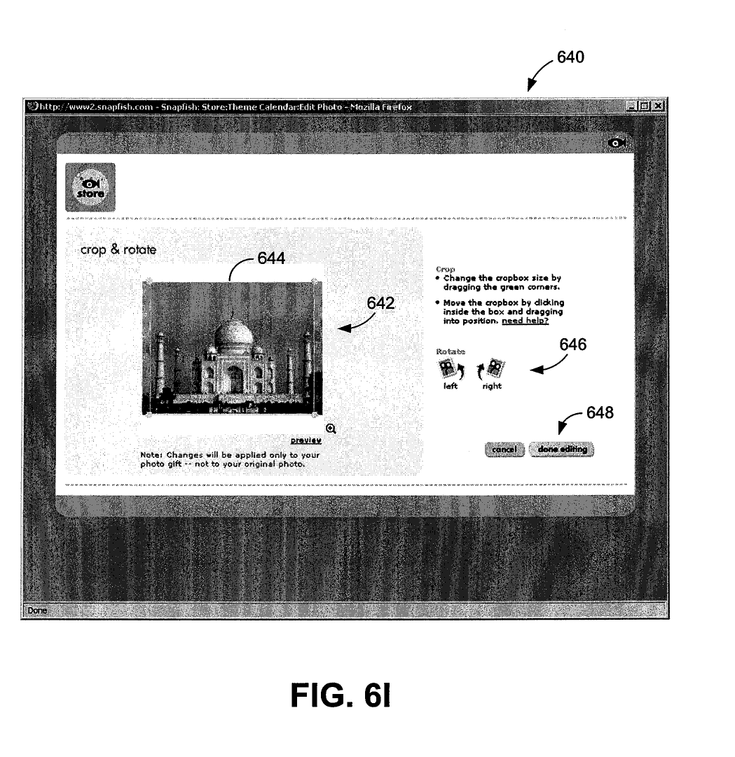

FIGS. 5A-5C illustrate a further example method for creating a personalized calendar. Beginning with block 500 of FIG. 5A, a user accesses an imaging service and, in response, content is presented to the user. In some embodiments, the user accesses a network site (e.g., web site) of the imaging service with a browser that executes on the user's computer. In such cases, one or more network pages (e.g., web pages) are downloaded to the user's browser for review and interaction. FIG. 6A illustrates an example web page 600 that can be presented to the user. As indicated in that figure, various options are presented to the user, including a “create a Calendar” option. Specifically, the “create a Calendar” option is identified by a selectable onscreen button 602.

Returning to FIG. 5A, the user can select the calendar creation option presented in the received content, as indicated in block 502. In the example of FIG. 6A, such selection comprises “clicking” on the button 602. Once the calendar creation option has been selected, content specific to creation of a personalized calendar can be presented to the user. FIG. 6B illustrates an example of such content in the form of a further web page 604.

With the presentation of content as indicated in block 502 of FIG. 5A, calendar creation begins and the user is prompted to select a starting month, as indicated in block 504. By enabling the user to select a starting month, the calendar can be customized to suit the user's data range preference and, therefore, need not begin on a month that may have already passed, such as January. Therefore, assuming a twelve-month calendar, if the user were to select “April” as the starting month, the calendar would include each month in the range of April of the current year to March of the next year. With reference back to FIG. 6B, the user can be prompted to select the starting month with a drop-down menu 606. Returning to FIG. 5A, once the user makes his or her month selection, the section is received and stored, as indicated in block 506.

The user can also be prompted to select a particular calendar style, as indicated in block 508. Such styles may define the look and feel of the calendar and may dictate one or more of the background color of the calendar and its various pages and any graphics that are placed in the background. In some embodiments, the styles available for selection include seasonal, black and white, studio, baby girl, baby boy, retromodern, vintage, and basic. With reference back to the example of FIG. 6B, the user can be prompted to select the desired calendar style with selection “boxes” 608 associated with representations of the available styles. Once the user makes his or her style selection, the selection is received and an indication of the selected style is presented to the user, as indicated in block 510 of FIG. 5A. By way of example, the selected style can be shown in use on a sample calendar to provide the user with an idea of how his or her personalized calendar may appear once completed. As indicated in the example of FIG. 6B, a sample calendar 610 can be shown to the user on the same page as the selection boxes 608 and the style of the sample calendar can be changed real-time to match a selected style.

With reference to block 512 of FIG. 5A, the user can next be prompted to select one or more images to be used on the cover of the calendar. FIG. 6C illustrates an example of a further web page 612 that can be used for that purpose. In FIG. 6C, the user is presented with a graphical representation of the calendar cover 614 and reduced-size views (e.g., “thumbnail” views) 616 of photographic images that can be added to the calendar cover. In some embodiments, the images available for use on the cover comprise all of the images of an electronic photograph album of the user that is maintained by the imaging service (e.g., in database 316 in FIG. 3). In such a case, the user can be provided with the option to select a different album, for example with a selectable on screen button 618.

Turning to block 514 of FIG. 5A, the user's selection of one or more images for the calendar cover can be received and an indication of the selected image(s) can be presented to the user to provide the user with an idea of how his or her personalized calendar will look upon completion. Returning to the example of FIG. 6C, the user can register his or her image selections using a drag-and-drop process in which an image (e.g., the reduced-sized view 616) is dragged to the cover representation 614 and released thereon using a mouse. Once the image is released on the cover representation 614, the image is positioned on the representation in a manner indicative of how the image would appear on the calendar cover. Notably, only one image may be provided on the cover or multiple images may be provided on the cover.

Referring next to block 516 of FIG. 5B, the user is prompted to input a textual caption for the calendar cover. As indicated in the example of FIG. 6C, the user may be so prompted with a selectable message 620 that states “click to add caption.” When that message 620 is selected, a pop-up box (not shown) can be presented to the user that includes a text field for entry of whatever text the user would like to add to the calendar cover. Assuming the user wishes to add text to the cover, the selected caption is received and an indication of the caption is presented to the user, as indicated in block 518. In the example of FIG. 6C, the caption can be added to the cover representation 614 in similar manner to addition of the selected image(s) to the cover representation. In some embodiments, the caption is inserted below or on top of the image(s).

Once any images and captions to be provided on the calendar cover have been selected and received, the user can be prompted to select a month to “build” or personalize, as indicated in block 520 of FIG. 5B. FIG. 6D illustrates an example of a further web page 622 that can be used to so prompt the user. As shown in FIG. 6D, the user can be presented with various selectable month icons 624 that can be selected by the user to indicate a month that is to be built. With reference back to FIG. 5B, the user's month selection can be received and an indication of the selected month can be presented to the user, as indicated in block 522. Returning to the example of FIG. 6D, the selected month can include a main image page representation 626 and a date cell page representation 628 that respectively represent a main image page that can be used to display one or more of the user's images and a date cell page that identifies the various days of the selected month. In some embodiments, the calendar can comprise a two-page pin-up format in which the main image page is positioned above the date cell page. Notably, however, other arrangements are possible, such as side-by-side arrangements in which the main image page is positioned to the side of the date cell page.

The user can then be prompted to select one or more main images for the selected month, as indicated in block 524 of FIG. 5B, and the selection(s) can be received and an indication of the selection(s) can be presented to the user, as indicated in block 526. As depicted in the example of FIG. 6D, the user can be prompted to drag-and-drop an image onto the main image page representation 626 in similar manner to that described above in relation to the calendar cover. As indicated in the example of FIG. 6E, the selected image can be positioned on the main image page representation 626 to provide the user with an idea of what that page will look like when the calendar is finalized. In the example of FIG. 6E, a picture of a “sunset” has been added to the main image page. In some embodiments, the user can add multiple images to the main image page, if desired. In such cases, the user can be presented with multiple options as to the arrangement of the multiple images. For example, multiple predetermined arrangements may be presented to the user for selection. Turning to the example of FIG. 6E, a desired arrangement can be selected from a drop-down menu 632 presented adjacent the main image page representation 626.

Referring next to block 528 of FIG. 5B, the user is prompted to input a textual caption for the main image page associated with the selected month. In the example of FIG. 6E, the user may be so prompted with a selectable message 634 that states “click to add caption.” When that message is selected, a pop-up box (not shown) can be presented to the user with a text field for entry of whatever text the user would like to add to the main image page for that month. Assuming the user wishes to add text to the main image page, the selected caption is received and an indication of the caption is presented to the user, as indicated in block 530. In the example of FIG. 6E, the caption can be added to the main image page representation 626 in similar manner to the addition of text described above in relation to the cover page.

Up until this point, personalization of a calendar has been accomplished through the addition of images and/or text to a cover of the calendar and main image pages associated with selected months of the calendar. In addition, however, personalization can comprise personalization of the individual date cells of those months. Therefore, if one or more of the days of the month are somehow significant to the user, the user can personalize those days through the addition of various content. As described in the following, individual date cells can, in some embodiments, be personalized through the addition of photographic images and/or text that the user selects.

Referring now to block 532 of FIG. 5C, the user is prompted to select a specific date to which to add content. In the example of FIG. 6E, each date cell 636 of the date cell page representation 628 is selectable by the user, for instance by “clicking” on the date cell using a mouse. Irrespective of how the user is prompted, however, a date selection can be received and the user can be prompted to select an image and/or text for the selected date, as indicated in block 534 of FIG. 5C. FIG. 6F illustrates an example manner of prompting the user to select an image and/or text. In FIG. 6F, a pop-up box 638 has appeared responsive to a user selecting a particular date, specifically May 18, 2007. The pop-up box 638 includes an image box 640 on which a selected image can be dragged and dropped and a text field 642 in which various desired text can be input.

Once the user selects any content (e.g., image and/or text) for the selected date, the content selections are received and an indication of the selected content is presented to the user, as indicated in block 536 of FIG. 5C. Referring to the example of FIG. 6G, a selected image and selected text are shown added to the pop-up box 638. In this example, the image is an image of the Taj Mahal and the text identifies “India Trip!” As a further indication of the selected content, the image and text can be shown in place within the date cell page representation 628 as indicated in FIG. 6H. Notably, the calendar can be pre-populated with relevant holiday information, such as information regarding holidays recognized by a country in which the web site is hosted. For instance, the in the example of FIG. 6H, May 28, 2007 is identified as “Memorial Day.”

As can be appreciated from the above, the inclusion of an image and/or text can more quickly and easily convey the significance of a given date to the user. In addition, the inclusion of such content not only reminds the user of an upcoming date but may further generate excitement and anticipation of an event that occurs on or is associated with the date.

Content can be added to any date of a selected month. Indeed, the user can add images and/or text to each day of the month, if desired. Therefore, with reference to decision block 538 of FIG. 5C, flow can return to block 532 if the user has not added all his or her content for the selected month. Once all content has been added, however, flow continues to decision block 540 at which continued flow depends upon whether the user has built each desired month of the calendar or whether the user has more building to perform. In the latter case, flow returns to block 520 at which the user can be prompted to select another month to build. In such a case, flow progresses from block 520 in the manner described above.

If all building has been completed, for example the user has added images and/or text to each month's main image page and has added images and/or text to each desired day of each month, flow continues to block 542 at which the user is prompted to review and approve the calendar. Assuming that the user does approve of the personalized calendar the user has created, that approval is received and the personalized calendar is stored in relation to the user, as indicated in block 544.

It is noted that, in some embodiments, storing of the calendar can include storing of the various images and text selected by the user in association with one or more months and/or dates for use in automatically generating future calendars. For example, if the user added a picture of his or her mother and text that says “Mom's Birthday” on Jul. 1, 2007, the picture and text can be stored in association with the date of July 1. The next time the user wishes to create a personalized calendar (e.g., one year later), the user can opt to import the content used from the previous calendar into the new calendar. Given that associations between that content and months and/or days of those months are stored, the new calendar can be automatically pre-populated with the content from the previous calendar, thereby reducing the amount of time and effort needed to create the new calendar. Therefore, if an association was stored between content (e.g., image and text) and Jul. 1, 2007 in a 2007 calendar the user created, the same content can be automatically associated with Jul. 1, 2008 in a 2008 calendar that the user may create at a later time.

Once all desired information has been stored, an account of the user can be billed, and the personalized calendar can be printed and shipped to the user, as indicated in block 546.

In some embodiments, photographic images added to the calendar can be edited after their addition to the calendar in the calendar creation process. For example, a given image editing options, such as cropping and/or rotating, can be presented to the user after the user selects an image that has already been added to a date cell 636 of the date cell page representation 628 (see FIG. 6E). FIG. 6I illustrates an example web page 640 that can be presented to the user in such a situation. As indicated in FIG. 6I, the selected image from the given date cell is presented to the user in an edit box 642 and the user can then crop the image using a cropping box 644 or rotate the image by selecting rotate control buttons 646. Once all desired editing has been performed, the editing can be approved by selecting a “done editing” button 648.

Although particular embodiments of systems and methods have been described in the foregoing, those embodiments are mere examples of the disclosed systems and methods. Therefore, other embodiments are possible and are considered to fall within the scope of the present disclosure.

The following are claimed:

1. A method for creating a personalized calendar, the method comprising:
prompting a user to select a date cell of a representation of a calendar to indicate a desire to add user content to that date cell;
receiving the date cell selection;
prompting the user to select user content for addition to the date cell;
receiving the user content selection; and
generating a personalized calendar that includes user content in at least one date cell of the calendar.

2. The method of claim 1, wherein receiving user content comprises receiving a photographic image and text input by the user.

3. The method of claim 1, wherein the prompting the user to select user content comprises presenting a web page to the user in the user's web browser.

4. The method of claim 1, wherein the prompting the user to select user content comprises presenting a pop-up box associated with the selected date cell, the pop-up box comprising an image box in which a photographic image can be positioned and a text field in which the user can enter text.

5. The method of claim 4, wherein the image box is configured to receive the photographic image in a drag-and-drop process performed by the user with a mouse.

6. The method of claim 4, wherein the photographic image and text can be added to the date cell in the calendar representation to provide the user with an idea of how the personalized calendar will look when completed.

7. The method of claim 6, further comprising enabling the user to edit the photographic image after it has been added to the date cell.

8. The method of claim 1, further comprising prompting the user to select a starting month for the calendar, wherein the first month presented in the calendar will be the selected starting month.

9. The method of claim 1, further comprising prompting the user to select a photographic image to be used on a cover page of the calendar and receiving the selected image.

10. The method of claim 9, further comprising prompting the user to select a textual caption to be provided on the calendar cover page along with the photographic image.

11. The method of claim 1, further comprising prompting the user to select a main photographic image for a particular calendar month, wherein the main photographic image will be positioned on a page separate from a page that comprises the date cells.

12. The method of claim 11, further comprising prompting the user to select a textual caption to be provided along with the main photographic image.

13. The method of claim 1, further comprising printing the personalized calendar for the user.

14. A system for creating a personalized calendar, the system comprising:
means for prompting a user to select a date cell of a representation of a calendar to indicate a desire to add user content to that date cell;
means for receiving the date cell selection;
means for prompting the user to select user content for addition to the date cell;
means for receiving the user content selection; and
means for generating a personalized calendar that includes user content in at least one date cell of the calendar.

15. The system of claim 14, wherein the means for receiving user content comprise means for receiving a photographic image and text input by the user.

16. The system of claim 14, wherein the means for prompting and receiving comprise part of a web site stored on a computer-readable medium and accessible using a web browser.

17. A computer-readable medium that stores an imaging service, the imaging service comprising:
logic configured to prompt the user to select a first photographic image to be used on a main image page associated with a selected month;
logic configured to prompt the user to select a second photographic image and text to be added to a date cell of the selected month; and
logic configured to receive the user selections and generate a personalized calendar for the user.

18. The computer-readable medium of claim 17, wherein the logic configured to prompt a user to select a first photographic image comprises logic configured to present a visual representation of the main image page to the user with a web page, wherein the first photographic image can be incorporated into the visual representation.

19. The computer-readable medium of claim 17, wherein the logic configured to prompt the user to select a second photographic image and text comprises logic configured to present a visual representation of a date cell page to the user with a web page, wherein the second photographic image and the text can be incorporated into the visual representation within the date cell.

20. The computer-readable medium of claim 19, wherein the logic configured to prompt the user to select a second photographic image and text further comprises logic configured to present a pop-up box associated with the date cell, the pop-up box comprising an image box in which the second photographic image can be dropped and a text field in which the user can enter the text.

21. The computer-readable medium of claim 19, further comprising logic configured to enable the user to edit the second photographic image after it has been incorporated into the date cell of the visual representation.

22. The computer-readable medium of claim 17, further comprising logic configured to store the user selections and using them to automatically populate a separate calendar.

23. The computer-readable medium of claim 17, further comprising logic configured to prompt the user to select a third photographic image to be used on a cover page of the calendar.
